(19) United States
(12) Patent Application Publication
(10) Pub. No.: US 2025/0210016 A1
(43) Pub. Date: Jun. 26, 2025

(54) Educational Piano

(71) Applicant: Springer Music Studio, LLC., West Melbourne, FL (US)

(72) Inventor: Jonathan Springer, Melbourne, FL (US)

(21) Appl. No.: 18/393,138

(22) Filed: Dec. 21, 2023

(51) Int. Cl. G10H 1/00; G09B 15/00

(52) U.S. Cl. CPC G10H 1/0016; G09B 15/003; G10H 2220/066

(57) ABSTRACT

A piano system including a keyboard, a sound output device, a light-emitting apparatus, a plurality of sound samples, a mapping of the keyboard to the sound samples, a mapping of the keyboard to colors emittable by the light-emitting apparatus, and a controller operably coupled to the keyboard, the sound output device, and the light-emitting apparatus, being operable to identify and play sound samples of depressed keys, identify and operate the light-emitting apparatus to emit colors associated with depressed keys, and, when two or more keys are depressed, identify and operate the light-emitting apparatus two emit two colors associated with the depressed keys.

### FIELD OF THE INVENTION

The present invention relates to systems and methods for keyboards configured to project light onto the keys for an educational purpose and retrofit kits for the same purpose.

### SUMMARY OF THE INVENTION

With the above in mind, embodiments of the present invention are related to a piano system comprising a keyboard that comprises a plurality of keys and a plurality of key switches, each key switch being actuatable by a key of the plurality of keys. The piano system further comprises a sound output device and a light-emitting apparatus comprising a plurality of multi-color light-emitting elements, the light-emitting apparatus being positioned to emit light onto an upper surface of the plurality of keys, and the light-emitting elements being operable to emit light in a plurality of colors, The piano system further comprises a non-transitory computer-readable medium having stored thereon a plurality of sound samples, a mapping associating each key switch of the plurality of key switches with a sound sample of the plurality of sound samples, and a mapping associating each key switch with a color of the plurality of colors capable of being emitted by the plurality of light-emitting elements. The piano system further comprises a controller operably coupled to each of the plurality of key switches, the sound output device, the light-emitting apparatus, and the non-transitory computer-readable medium, the controller being configured to receive an input from each key switch of the plurality of key switches, identify an identified sound sample associated with the key switch from which the input was received, play the identified sound sample for a duration the input is received, identify an identified color associated with the key switch from which the input was received, operate the light-emitting apparatus such that at least one light-emitting element of the plurality of light-emitting elements is emitting the identified color for the duration the input is received, and, when receiving two or more concurrent inputs from two or more key switches, identify a first identified color associated with a first key switch from one of the two or more concurrent inputs was received, identify a second identified color associated with a second key switch from another of the two or more concurrent inputs was received, and operate the light-emitting apparatus such that a pattern resulting from at least one light-emitting element of the plurality of light-emitting elements emitting the first identified color and at least one light emitting element of the plurality of light-emitting elements emitting the second identified color.

Additionally, further embodiments of the invention are directed to a kit for retrofitting a piano comprising a keyboard comprising a plurality of keys and a plurality of key switches actuatable by the keys and a sound output device, the kit comprising a light-emitting apparatus comprising a plurality of multi-color light-emitting elements, the light-emitting apparatus being configured to be positioned to emit light onto an upper surface of the plurality of keys, and the light-emitting elements being operable to emit light in a plurality of colors, a non-transitory computer-readable medium having stored thereon a plurality of sound samples, a mapping associating each key switch of the plurality of key switches with a sound sample of the plurality of sound samples; and a mapping associating each key switch with a color of the plurality of colors capable of being emitted by the plurality of light-emitting elements. The kit may further comprise a controller configured to be coupled to each of the plurality of key switches, the sound output device, the light-emitting apparatus, and the non-transitory computer-readable medium, the controller being configured to receive an input from each key switch of the plurality of key switches, identify an identified sound sample associated with the key switch from which the input was received, play the identified sound sample for a duration the input is received, identify an identified color associated with the key switch from which the input was received, operate the light-emitting apparatus such that at least one light-emitting element of the plurality of light-emitting elements is emitting the identified color for the duration the input is received, and, when receiving two or more concurrent inputs from two or more key switches, identify a first identified color associated with a first key switch from one of the two or more concurrent inputs was received, identify a second identified color associated with a second key switch from another of the two or more concurrent inputs was received, and operate the light-emitting apparatus such that a pattern resulting from at least one light-emitting element of the plurality of light-emitting elements is emitting the first identified color and at least one light emitting element of the plurality of light-emitting elements is emitting the second identified color.

Further embodiments of the invention are directed to a method of providing visual responses when using a keyboard comprising a plurality of keys and a plurality of key switches, each key switch being actuatable by a key of the plurality of keys, a sound output device, and a light-emitting apparatus comprising a plurality of multi-color light-emitting elements, the light-emitting apparatus being positioned to emit light onto an upper surface of the plurality of keys, and the light-emitting elements being operable to emit light in a plurality of colors, a non-transitory computer-readable medium having stored thereon a plurality of sound samples, a mapping associating each key switch of the plurality of key switches with a sound sample of the plurality of sound samples, and a mapping associating each key switch with a color of the plurality of colors capable of being emitted by the plurality of light-emitting elements, and a controller operably coupled to each of the plurality of key switches, the sound output device, the light-emitting apparatus, and the non-transitory computer-readable medium. The method may comprise receiving two or more concurrent inputs from two or more key switches, identifying an identified sound sample associated with each key switch from which the inputs of the two or more concurrent inputs was received, playing the identified sound sample for a duration of the inputs of the concurrent inputs are received, identifying a first identified color associated with a first key switch from one of the two or more concurrent inputs was received, identifying a second identified color associated with a second key switch from another of the two or more concurrent inputs was received, and operating the light-emitting apparatus to emit light onto the upper surface of the plurality of keys such that a pattern resulting from at least one light-emitting element of the plurality of light-emitting elements emitting the first identified color and at least one light emitting element of the plurality of light-emitting elements emitting the second identified color.

### BRIEF DESCRIPTION OF THE DRAWINGS

Some embodiments of the present invention are illustrated as an example and are not limited by the figures of the accompanying drawings, in which like references may indicate similar elements.

FIG. 1 is a perspective view of a piano system according to an embodiment of the present invention.

FIG. 2 is a view of a light-emitting apparatus comprised by the piano system of FIG. 1.

FIG. 3 is a side view of the piano system of FIG. 1 depicting the emission of light onto the keys of the keyboard.

FIG. 4 is a schematic view of the piano system of FIG. 1.

FIGS. 5a-e are partial front views of a piano system according to an embodiment of the invention when none, one, two at a first moment in time, two at a second moment in time, and three keys of the keyboard thereof are depressed, respectively.

FIG. 6 is a sound graph of a sound produced by a piano system according to an embodiment of the invention when a single key is pressed.

FIG. 7 is a sound graph of sounds produced by a piano system according to an embodiment of the invention when multiple keys are pressed and released at different times.

FIG. 8 is a schematic view of a piano retrofit kit according to an embodiment of the invention.

FIG. 9 is a flowchart illustrating a method of operating a piano system according to an embodiment of the invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a piano system with light-based educational functionality. Referring to FIGS. 1-8, a piano system 100 according to an embodiment of the invention is presented. The piano system 100 comprises a frame 101 and a keyboard 110. The frame 101 may be configured to permit the piano system 100 to be placed on a floor or other generally flat surface.

The frame 101 may comprise one or more legs 102 or other support members, an upper section 104, and a keyboard backwall 105. In the present embodiment the frame 101 comprises four legs 102. The frame 101 further comprise distal extension sections 106 extending in a distal direction. The distal extension sections 106 may facilitate attachment and support of the keyboard 110. The upper section 104 may be one of attached to and integrally formed with an upper section or end of the vertical extension members 103. Such connection may provide for lateral stability of the piano system. In some embodiments, the upper section 104 may be configured to at least partially open, simulating a grand piano as is known in the art. The upper section 104 may further comprise an overhang section 108 configured to extend in a distal direction and be positioned at least partially vertically over at least a portion of the keyboard 110. A light-emitting apparatus 120 of the piano system 100 may be attached to a lower surface 109 of the overhang 108, as will be discussed in greater detail below.

The keyboard backwall 105 may also extend between the vertical extension members 103 proximally and proximate to the keyboard 110, such that the keyboard backwall 105 extends upward from the keyboard 110. In some embodiments, the keyboard backwall 105 may extend up to the upper section 104. The keyboard backwall 105 may be configured to reflect light incident thereupon. Furthermore, such reflection may be diffusive. In some embodiments, the keyboard backwall 105 may be configured to reflect light of any color, such that the user is able to accurately perceive the color of light incident upon the keyboard backwall 105. In some embodiments, the keyboard backwall 105 may be configured to have a white surface. Such a white surface may be the result of the material the keyboard backwall 105 is formed from or a material applied to the surface of the keyboard backwall 105, such as paints, inks, varnishes, dyes, surface treatments, polishes, laminates, claddings, or any other substance, material, or product that may be so positioned.

The keyboard 110 may comprise a plurality of keys 112. The plurality of keys 112 may be depressible by the user to generate one or more tones, which each key of the plurality of keys 112 being associated with a single tone/musical note. In the present embodiment, the keyboard 110 comprises keys consistent with traditional pianos, including multiple white, elongated keys and multiple black, shortened keys that are positioned above but interspersed with the white keys. The plurality of keys 112 shown in the present embodiment are exemplary only and any keys as are known in the art of keyboards is contemplated and included within the scope of the invention.

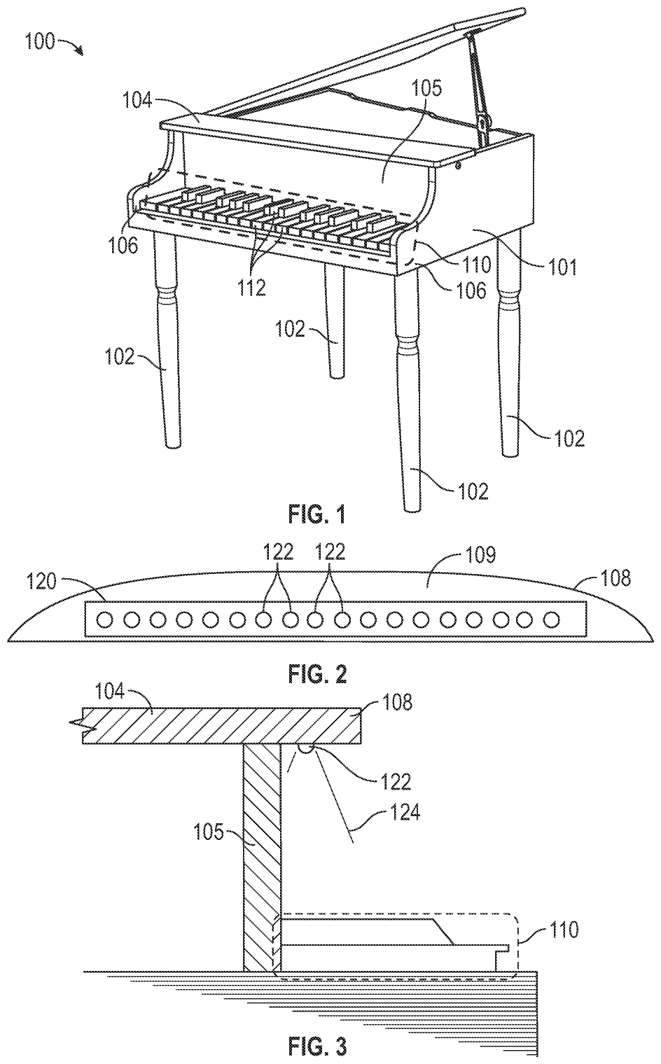

As shown in FIGS. 2-3, the light-emitting apparatus 120 may be attached to the lower surface 109 of the overhang 108. The light-emitting apparatus 120 may be operable to emit light. The light-emitting apparatus 120 may comprise a plurality of light-emitting elements 122. The light-emitting elements 122 may be distributed along a length of the light-emitting apparatus 120. In some embodiments, the light-emitting apparatus 120 may be a strip of light-emitting elements, such as light-emitting diodes (LEDs). The plurality of light-emitting elements may distributed along the length of the light-emitting apparatus 120 such that light emitted by the light-emitting apparatus 120 may illuminate all or substantially all of at least one of the keyboard backwall 105 and the plurality of keys 112 of the keyboard 110.

Moreover, the light-emitting apparatus 120 may be positioned on the overhang 108 sufficiently far in a proximal direction that light emitted by the light-emitting apparatus 120 may be likely to be shielded from direct observation by a user by the overhand 108. Accordingly, observation of light emitted by the light-emitting apparatus 120 may be largely and/or exclusively observable by a user sitting on a bench, chair, stool, or other seating device in front of the piano system 100 as it is reflected by the keyboard 110 and/or the keyboard backwall 105. The light-emitting elements 122 may be configured to emit light into a field of illumination 124. The light-emitting elements 122 may be positioned and/or configured such that the field of illumination 124 is predominately or entirely directed to the keyboard 110 and/or the keyboard backwall 105. Such configuration may include optical shaping by an optical element and/or housing comprised by an LED lamp as described above. It is contemplated that the field of illumination 124 may include light of decreasing intensity as the angular distance from an azimuth of the field of illumination 124 increases, and that the depiction of the field of illumination 124 shown in FIG. 3 may represent a distribution of light intensity above a threshold intensity value to define a majority of light emitted by the light-emitting element 122.

The plurality of light-emitting elements 122 may each by operable to emit light in one of a variety of colors. In some embodiments, the light-emitting elements may be tri-color LED lamps comprising three colored LEDs and operable to emit each of the three colored LEDs independently that can mix to produce an emitted light of a color different from any one of the three colored LEDs. An example of such tri-color LED lamps are red, green, and blue (RGB) lamps. Such a lamp is exemplary only, and any type of multi-colored LED device as is known in the art is contemplated and included within the scope of the invention.

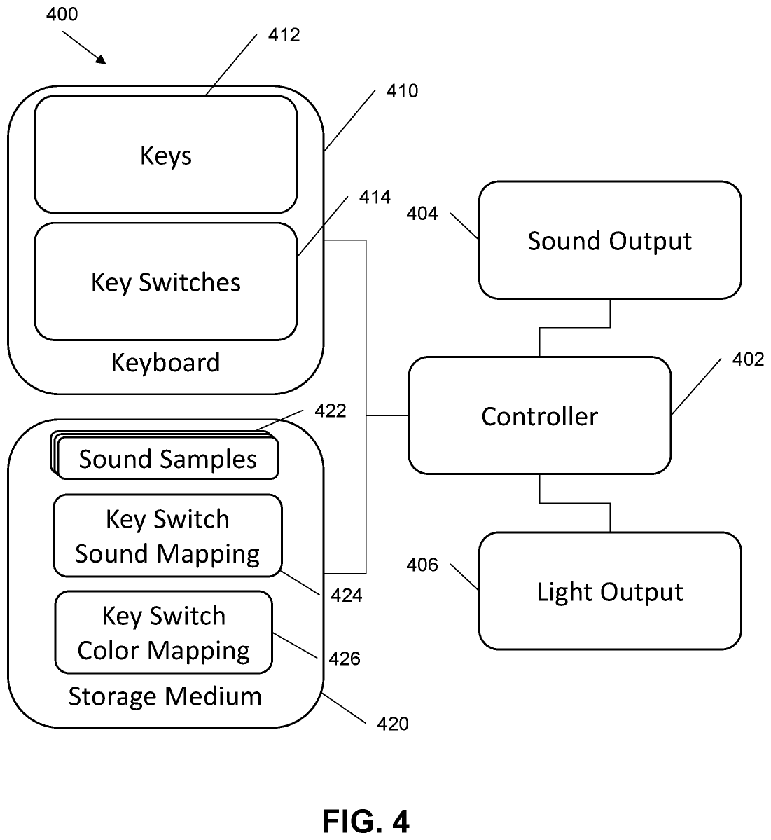

Referring now to FIG. 4, computerized aspects of a piano system 400 according to an embodiment of the invention is presented. The piano system 400 comprises a keyboard 410, a storage medium 420, a controller 402, a sound output system 404, and a light output system 406. The light output system 406 may be the light-emitting apparatus 120 of piano system 100 as described above. The sound output system 404 may be any device operable to emit sound across a frequency spectrum as is known in the art, including, but not limited to, loudspeakers, such as electroacoustic transducers, piezoelectric speakers, and the like. The controller 402 may be any computerized controller device as is known in the art, including, but not limited to, microcontrollers, integrated circuits, processors, microprocessors, central processing units, field-programmable gate arrays, and the like. The controller 402 may be operably connected to each of the sound output system 404 and the light output system 406 and be configured to operate said systems.

The keyboard 410 may comprise a plurality of keys 412 as mentioned above. The keyboard 410 may further comprise a plurality of key switches 412. Each key of the plurality of keys 412 may have an associated key switch of the plurality of key switches 414. The plurality of key switches 414 may be positioned such that, when the key of the plurality of keys 412 with which it is associated is depressed by the user, the key switch is actuated. Types of keyboard switches comprised by the plurality of keyboard switches include, but are not limited to, pushbutton switches, mechanical switches, magnetic switches, opto-mechanical switches, capacitive switches, membrane switches, mecha-membrane switches, scissor switches, optical switches, and the like. In some embodiments, the more than one key switch of the plurality of key switches 414 may be associated with each key of the plurality of keys 412.

The controller 402 may be positioned in communication with the key switches of the plurality of key switches 414. In some embodiments, the controller 402 may be directly connected with each key switch. In other embodiments, the controller 402 may be connected to the plurality of key switches 414 via a keyboard matrix circuit, reducing the number of physical connections to the controller 402 for the controller 402 to be able to determine which key switch of the plurality of key switches 414 is depressed. Additionally, the controller 402 may be configured to determine at what point in time the key switches of the plurality of key switches 414 are depressed. In some embodiments, one or both of the plurality of key switches 414 and/or the controller 402 may be configured to determine with how much force and/or velocity the key switch is depressed.

The piano system 400 further comprises a storage medium 420. The storage medium 420 may be any type of computer-readable, non-volatile storage medium as is known in the art. Types of media include, but are not limited to, semiconductor devices, such as solid state drives (SSDs), flash drives, non-volatile random-access memory, magnetic devices, such as hard disk drives (HDDs), magnetic tape, and the like, and optical storage media, including compact discs, digital video discs, Blu-ray discs, ultra density optical devices, and the like. The controller 402 may be in communication with the storage medium 420 and operable to read, write, and/or delete information from the storage medium 420.

The storage medium 420 may have data stored thereon to facilitate operation of the piano system 400. The storage medium 420 may comprise one or more sound samples 422 stored as files and/or in a database on the storage medium. The sound samples 422 may be audio files that may be accessed by the controller 402 and played back on the sound output device 404 responsive to the controller 402 receiving an input from a key switch of the plurality of key switches 414. In some embodiments, the sound samples 422 may comprise multiple sound samples associated with a given key switch of the plurality of key switches 414 that may be different in terms of intensity, drop-off, or some other characteristic and may be selected based upon characteristics of the input received from the key switch, such as force or velocity with which the key associated with the key switch is depressed.

The storage medium 420 may further have stored thereon a mapping of key switches to sound samples 424. The key switch sound mapping 424 may be accessed and interpreted by the controller 402 to provide instructions to the controller 402 which sound sample 422 to retrieve and play back responsive to receiving an input from a particular key switch of the plurality of key switches 414. More specifically, in some embodiments, when the controller 402 receives an input from a keyboard matrix circuit and identifies the key switch from which the input is received, the controller 402 may access the key switch sound mapping and identify which sound sample of the sound samples 422 stored on the storage medium 420 is associated with the identified key switch. The controller 402 may then access and retrieve the identified sound sample and play back the sound sample on the sound output system 404. It is contemplated and included within the scope of the invention the controller 402 may modify the playback of the identified sound sample responsive to at least one of a duration during which the input is received, a sound modification setting received from the user, including, but not limited to, echo, reverb, tone, timbre, volume, sustain, damper, and any other sound quality as is known in the art. It is further contemplated and included within the scope of the invention that the controller 402 may be configured to receive multiple inputs from the plurality of key switches 414 at the same time and to retrieve and play back multiple sound samples 422 associated with the multiple key switches from which inputs are received from the sound output system 404 simultaneously, with the playback of the multiple sound samples starting and/or stopping at the same or different times, depending on when the multiple inputs are received and cease being received.

The storage medium 420 may further have stored thereon a mapping of key switches to colors to be emitted by the light output system 406. More specifically, each key switch of the plurality of key switches 414 may have a color of light associated therewith, and the key switch color mapping 426 may identify what color of light is associated with the key switch from an input is received. When the controller 402 receives an input from a key switch of the plurality of key switches 414, the controller 402 may access the key switch color mapping 426, identify the color of light associated with the key switch from which an input was received, and then operate the light output system 406 to emit the identified color. When the controller 402 receives a plurality of inputs from a two or more key switches of the plurality of key switches 414, the controller 402 may access the key switch color mapping 426, identify the one or more colors of light associated with the each key switch of the two or more key switches from which an input of the plurality inputs was received, and then operate the light output system 406 to emit each identified color. Additional details regarding operation of the light output system 406 will be provided in greater detail below.

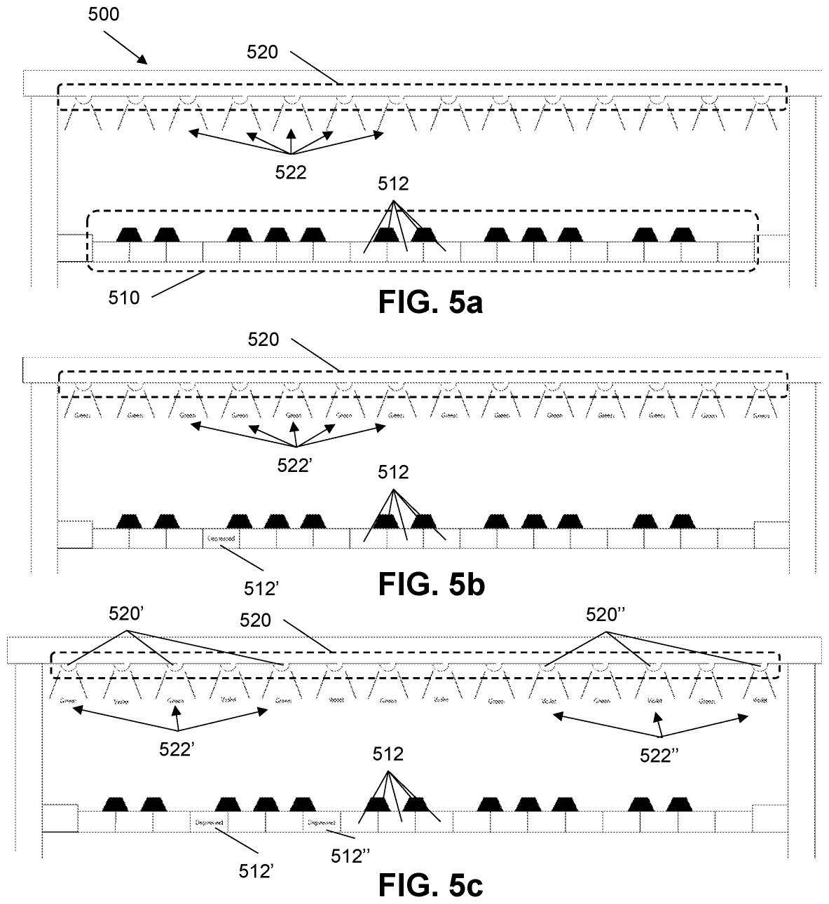

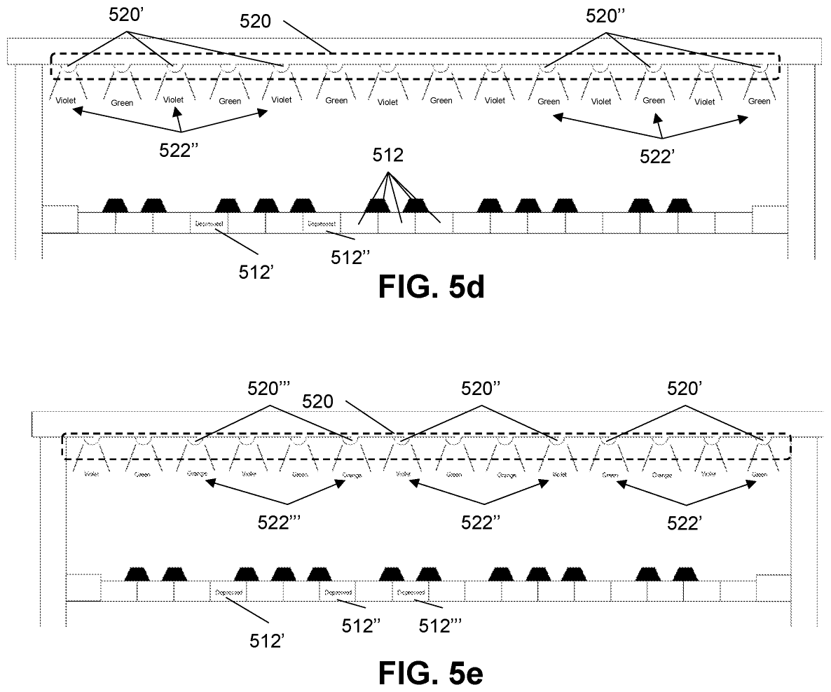

Referring now to FIGS. 5a-d, additional aspects of operation of a piano system 500 according to an embodiment of the invention is presented. As shown in FIGS. 5a-d, the piano system comprises a keyboard 510 including a plurality of keys 512. The piano system 500 further comprises a plurality of multi-color light-emitting elements 520. Each light-emitting element has an associated illumination field 522. In FIG. 5a, none of the keys of the plurality of keys 512 are depressed. While the illumination fields 522 are depicted in FIG. 5a, in this figure no light is being emitted from the plurality of light-emitting elements 520.

Referring now to FIG. 5b, a first key 512′ of the plurality of keys 512 is being depressed. As described above, depression of the first key 512′ actuates one or more key switches (not shown) to transmit an input to a computerized device of the piano system 500. That computerized system identifies a color associated with the first key 512′/key switch associated with the first key 512′ from a key switch color mapping stored on the piano system 500. Also as shown in FIG. 5b, the plurality of light-emitting elements 520 are being operated to emit green-colored light 522′. In the current embodiment, because a single key 512′ is being depressed, only green light is emitted from the plurality of light-emitting elements 520. While all light-emitting elements of the plurality of light-emitting elements 520 are shown to be emitting green light, it is contemplated and included within the scope of the invention that a single light-emitting element or a subgroup of the plurality of light-emitting elements 520 may be operated to emit light responsive to receiving an input from a key switch responsive to the first key 512′ being depressed. Moreover, while green is shown being emitted by the plurality of light-emitting elements 520, it is contemplated that any color of light may be associated with the first key 512′ and may be emitted responsive to the first key 512′ being depressed. Such colors include, but are not limited to, red, red-orange, orange-red, orange, orange-yellow, yellow-orange yellow, yellow-green, green-yellow, green, green-blue, blue-green, blue, blue-indigo, indigo-blue, indigo, indigo-violet, violet-indigo, violet, white, and variations thereof.

Referring now to FIG. 5c, the first key 512′ and a second key 512″ of the plurality of keys 512 are being depressed. As described above, depression of the first key 512′ and the second key 512″ actuates one or more key switches (not shown) associated with each of the first and second keys 512′, 512″ to transmit an input to a computerized device of the piano system 500. That computerized system identifies a first color associated with the first key 512′/key switch associated with the first key 512′ and a second color associated with the second key 512″/key switch associated with the second key 512″ from a key switch color mapping stored on the piano system 500. The first light 522′ may be different from the second light 522″. In the present embodiment, the first light 522′ is green and the second light 522″ is violet. The plurality of light-emitting elements 520 may then be operated to emit each of the first color and the second color. In the present embodiment, a first subset of light-emitting elements 520′ may be operated to emit the first color and a second subset of light-emitting elements 520″ to emit the second color.

In the present embodiment, the plurality of light-emitting elements 520 are approximately evenly distributed between the first and second subsets 520′, 520″. It is contemplated and included within the scope of the invention that the number of light-emitting elements comprised by the first and second subsets 520′, 520″ may be equal, as close to equal as is possible, or unequal. Moreover, it is contemplated and included within the scope of the invention that each subset of the first and second subsets 520′, 520″ may comprise at least one and at most one less than the total number of light-emitting elements of the plurality of light-emitting elements 520. Additionally, in the present embodiment, the plurality of light-emitting elements 520 are distributed between the first and second subsets 520′, 520″ such that an alternating pattern of green-violet-green-violet is emitted from the plurality of light-emitting elements 520. Such an emission pattern may result in a repeating striped pattern on the keyboard 510 and/or anywhere else light emitted by the plurality of light-emitting elements 520 is incident. It is contemplated and included within the scope of the invention that any pattern, repeating pattern, or non-repeating distribution of lights between the first and second subsets 520′, 520″. Additionally, the colors of green and violet for the first and second identified colors is exemplary only, and any of the colors identified above and as are known in the art are contemplated and included within the scope of the invention as being identified and emitted by the plurality of light-emitting elements 520.

Referring now to FIG. 5d, the keyboard as depicted in FIG. 5c is presented at a second moment in time subsequent to the depiction in 5c, which depicts a first moment in time. The first and second keys 512′, 512″ remain depressed. However, the plurality of light-emitting elements 520 are being operated to emit light that is different from the light emitted in FIG. 5c. Specifically, the first and second subsets 520′, 520″ have been changed such that at least one light-emitting element of the plurality of light-emitting elements 520 are emitting a different color of light. In the present embodiment, the first subset 520′ is now emitting the second light 522″ and the second subset 520″ is now emitting the first light 522′. It is further contemplated and included within the scope of the invention that the plurality of light-emitting elements 520 may be changed at a sufficiently fast speed such that light reflected by the keyboard 510 is perceived by the user as simulating motion of the light reflected thereby. Such simulation of motion may continue for as long as the first and second keys 512′, 512″ are simultaneously depressed. Should one of the first or second keys 512′, 512″ cease to be depressed, for example, the second key 512″, the piano system 500 may cease emitting the second identified color but continue emitting the first identified color.

Referring now to FIG. 5e, the first key 512′, the second key 512″, and a third key 512″ of the plurality of keys 512 are being depressed. As described above, depression of the first key 512′, the second key 512″, and the third key 512′″ actuates one or more key switches (not shown) associated with each of the first, second, and third keys 512′, 512″, 512′″ to transmit an input to a computerized device of the piano system 500. That computerized system identifies a first color associated with the first key 512′/key switch associated with the first key 512′, a second color associated with the second key 512″/key switch associated with the second key 512″, and a third color associated with the third key 512″/key switch associated with the third key 512″ from a key switch color mapping stored on the piano system 500. The first light 522′ may be different from the second light 522″ and the third light 522″ and the second light 522″ may be the third light 522′″. In the present embodiment, the first light 522′ is green, the second light 522″ is violet, and the third light 522′″ is orange. The plurality of light-emitting elements 520 may then be operated to emit each of the first color, the second color, and the third color. In the present embodiment, the first light 522′ is green, the second light 522″ is violet, and the third light 522″ is orange. The plurality of light-emitting elements 520 may then be operated to emit each of the first color, the second color, and the third color. In the present embodiment, a first subset of light-emitting elements 520′ may be operated to emit the first color, a second subset of light-emitting elements 520″ to emit the second color, and a third subset of light-emitting elements 520″ to emit the third light.

In the present embodiment, the plurality of light-emitting elements 520 are approximately evenly distributed between the first, second, and third subsets 520′, 520″, 520″. It is contemplated and included within the scope of the invention that the number of light-emitting elements comprised by the first second, and third subsets 520′, 520″, 520′″ may be equal, as close to equal as is possible, or unequal. Moreover, it is contemplated and included within the scope of the invention that each subset of the first, second, and third subsets 520′, 520″, 520″ may comprise at least one and at most two less than the total number of light-emitting elements of the plurality of light-emitting elements 520. Additionally, in the present embodiment, the plurality of light-emitting elements 520 are distributed between the first, second, and third subsets 520′, 520″, 520″ such that a pattern of violet-green-orange-violet-green-orange is emitted from the plurality of light-emitting elements 520. It is contemplated and included within the scope of the invention that any pattern, repeating pattern, or non-repeating distribution of lights between the first, second, and third subsets 520′, 520″, 520″. Additionally, the colors of green, violet, and orange for the first, second, and third identified colors is exemplary only, and any of the colors identified above and as are known in the art are contemplated and included within the scope of the invention as being identified and emitted by the plurality of light-emitting elements 520.

In some embodiments, it is contemplated and included within the scope of the invention that the intensity of light emitted by the plurality of light-emitting elements may vary over time. In some embodiments, where a first key switch is activated at a first moment in time, the plurality of light-emitting elements may emit light in a first color associated with the first key switch at a maximum intensity, and then decrease the intensity of light emitted in the first color as time progresses so long as the first key switch is activated. In some further embodiments, where a second key switch is activated at a second moment in time subsequent to the first moment in time, while the first key switch is still activated, the plurality of light-emitting elements may emit light in the first color at an intensity less than a maximum intensity and may further emit light in a second color associated with the second key switch at a maximum intensity, with the intensity of light emitted in the first and second colors decreasing as time progresses so long as both the first and second key switches are activated. Any number of simultaneously-activated key switches and concordant emission of light in colors corresponding to the activated key switches and the decreasing of intensity of light emitted in the concordant colors as time progresses while the key switches are activated and inputs are received therefrom is contemplated and included within the scope of the invention.

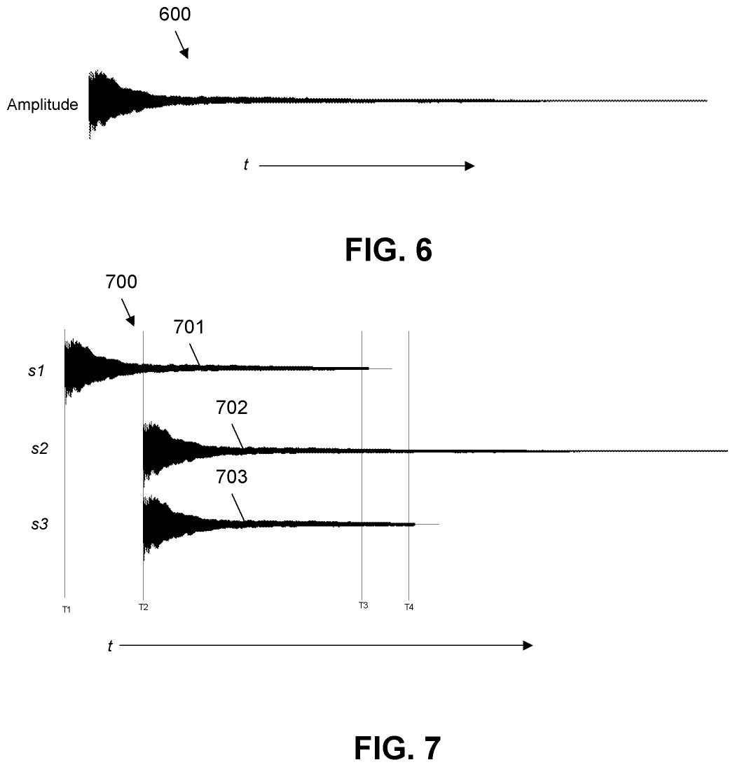

Referring now to FIG. 6, a sound graph 600 of a sound sample according to an embodiment of the invention is presented. As mentioned above, a piano system according to an embodiment of the invention provides for identifying a sound sample from a plurality of sound samples by accessing a mapping of key switch sound mappings, retrieving the sound sample, and playing back the sound sample on a sound output device. The sound graph 600 may imitate the sound produced by a piano when a key is depressed. In the present embodiment, the amplitude of the sound graph 600 starts out at a maximum and decreases as time t increases, with variability resembling that of a note being played on a piano. A sound sample associated with each key on the keyboard as described above may have a similar sound graph.

Referring now to FIG. 7, a sound graph 700 of multiple sound samples is presented. The sound graph 700 depicts the playback of three sound samples, sound sample s1 701, sound sample s2 702, and sound sample s3 703. Sound sample s1 701 is depicted as being played back starting at time T1, corresponding to a first moment in time at which the input from a key switch associated with the sound sample being played back and depicted as s1 701 is first received. Sound samples s2 and s3 702, 703 are depicted as being played back starting at time T2, corresponding to a second moment in time at which inputs from key switches associated with the sound samples being played back and depicted as s2 702 and s3 703, respectively, are first received. The sound graph 700 further depicts the sound sample s1 701 terminating shortly after time T3, representing a third moment in time at which the input from the key switch associated with the sound sample s1 ceased to be received, indicating the key on the keyboard associated therewith is no longer depressed. Sound samples s2 and s3 702, 703 continue playback after T3. The sound graph 700 further depicts the sound sample s3 703 terminating shortly after time T4, representing a fourth moment in time at which the input from the key switch associated with the sound sample s3 ceased to be received, indicating the key on the keyboard associated therewith is no longer depressed. Sound sample s2 702 continues playback after T4. Sound graph 700 presents the independent nature with which sound samples may be played back responsive to receiving inputs from key switches associated with the individual sound samples.

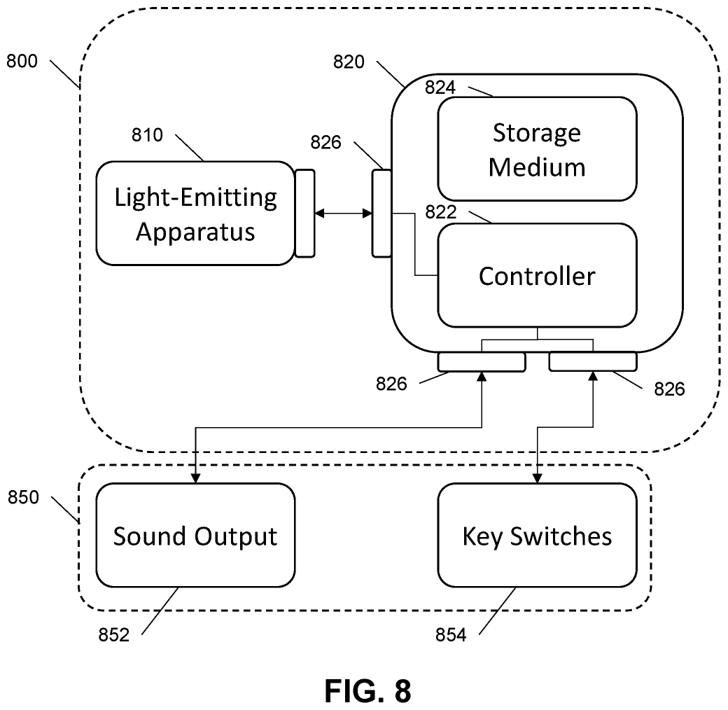

Referring now to FIG. 8, a kit 800 according to an embodiment of the invention is presented. The kit 800 may be configured to be attached to and placed in operable connection with elements of a piano system 850. The kit 800 may comprise a light-emitting apparatus 810 substantially as provided above. The light-emitting apparatus 810 may comprise a plurality of light-emitting elements on a substrate that is attachable to a surface of a piano device, such as the overhang as described and shown in FIGS. 1-3. Such attachment may be accomplished by any means or method as is known in the art, including, but not limited to, adhesives, glues, fasteners, hook-and-loop systems, magnetic attachment, and the like. The kit 800 may further comprise a controller apparatus 820. The controller apparatus 820 may comprise a controller device 822 and a non-volatile computer-readable storage medium 824, which are both identical to the storage medium 420 and the controller 402 as described for the embodiment depicted in FIG. 4. The controller apparatus 820 may comprise a plurality of ports 826 configured to permit coupling to one or more connectors (not shown) which may connect the controller apparatus 820 such that the controller 822 may be operably connected to the light-emitting apparatus 810 and a sound output device 852 and a plurality of key switches 854 comprised by the piano system 850. Such ports 826 may be any port known in the art, including, but not limited to, serial ports, such as Universal Serial Bus (USB) ports. The controller 822 may be configured to perform all the operation of receiving inputs from the key switches 854, accessing key switch sound and color mappings and sound samples comprised by the storage medium 824, and operate the light-emitting apparatus 810 and the sound output device 852 responsive to the retrieved identified colors and sound samples.

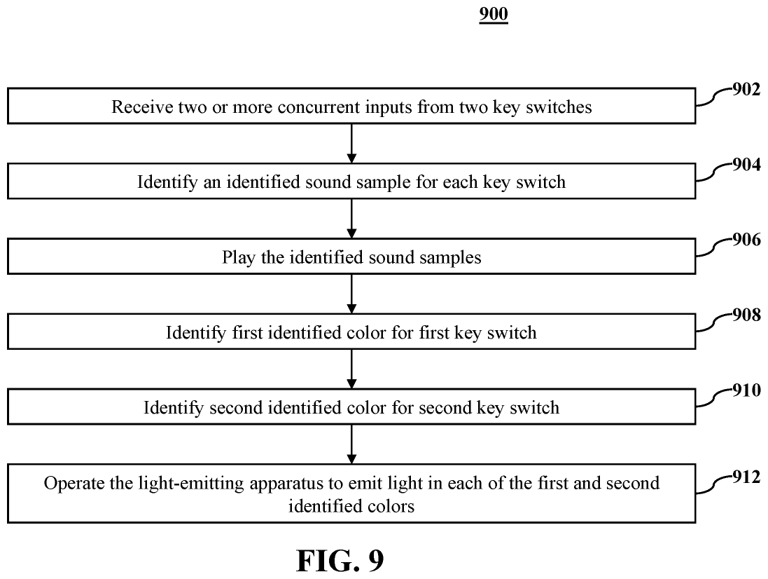

FIG. 9 is a flowchart of an example method 900. In some implementations, one or more process blocks of FIG. 9 may be performed by a piano system. As shown in FIG. 9, method 900 may include receiving two or more concurrent inputs from two or more key switches (block 902). For example, piano system may receive two or more concurrent inputs from two or more key switches, as described above. As also shown in FIG. 9, method 900 may include identifying an identified sound sample associated with each key switch from which the inputs of the two or more concurrent inputs was received (block 904). For example, piano system may identify an identified sound sample associated with each key switch from which the inputs of the two or more concurrent inputs was received, as described above. As further shown in FIG. 9, method 900 may include playing the identified sound sample for a duration of the inputs of the concurrent inputs are received (block 906). For example, piano system may play the identified sound sample for a duration of the inputs of the concurrent inputs are received, as described above. As also shown in FIG. 9, method 900 may include identifying a first identified color associated with a first key switch from one of the two or more concurrent inputs was received (block 908). For example, piano system may identify a first identified color associated with a first key switch from one of the two or more concurrent inputs was received, as described above. As further shown in FIG. 9, method 900 may include identifying a second identified color associated with a second key switch from another of the two or more concurrent inputs was received (block 910). For example, piano system may identify a second identified color associated with a second key switch from another of the two or more concurrent inputs was received, as described above. As also shown in FIG. 9, method 900 may include operating the light-emitting apparatus to emit light onto the upper surface of the plurality of keys such that a pattern resulting from at least one light-emitting element of the plurality of light-emitting elements emitting the first identified color and at least one light emitting element of the plurality of light-emitting elements emitting the second identified color (block 912). For example, piano system may operate the light-emitting apparatus to emit light onto the upper surface of the plurality of keys such that a pattern resulting from at least one light-emitting element of the plurality of light-emitting elements emitting the first identified color and at least one light emitting element of the plurality of light-emitting elements emitting the second identified color, as described above.

Although FIG. 9 shows example blocks of method 900, in some implementations, method 900 may include additional blocks, fewer blocks, different blocks, or differently arranged blocks than those depicted in FIG. 9. Additionally, or alternatively, two or more of the blocks of method 900 may be performed in parallel.

In some embodiments, the pattern resulting from at least one light-emitting element of the plurality of light-emitting elements emitting the first identified color and at least one light emitting element of the plurality of light-emitting elements emitting the second identified color is a repeating striped pattern.

In some further embodiments, a method may further comprise changing the color of light emitted by each light-emitting element of the plurality of light-emitting elements as time progresses, with a light-emitting element of the plurality of light emitting elements emitting the first identified color at a first moment in time during which the concurrent input of two or more key switches is received and the second identified color at a second moment in time subsequent to the first moment in time during which the concurrent input of two or more key switches is received, the concurrent input of the two or more key switches having been received continuously between the first moment in time and the second moment in time.

In some embodiments, a method may further comprise changing the color of light emitted by each light-emitting element of the plurality of light-emitting elements as time progresses, simulating motion of the pattern as it is observable by a user onto the upper surface of plurality of keys by.

In some embodiments, a method may further comprise, upon ceasing to receive an input from one of the two or more key switches with which the second identified color is identified while continuing to receive the other inputs of the two or more key switches, operating the light-emitting apparatus to emit at least the first identified color and to not emit the second identified color.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

What is claimed is:

1. A piano system comprising:
a keyboard comprising:
a plurality of keys; and
a plurality of key switches, each key switch being actuatable by a key of the plurality of keys;
a sound output device;
a light-emitting apparatus comprising a plurality of multi-color light-emitting elements, the light-emitting apparatus being positioned to emit light onto an upper surface of the plurality of keys, and the light-emitting elements being operable to emit light in a plurality of colors;
a non-transitory computer-readable medium having stored thereon:
a plurality of sound samples;
a mapping associating each key switch of the plurality of key switches with a sound sample of the plurality of sound samples; and
a mapping associating each key switch with a color of the plurality of colors capable of being emitted by the plurality of light-emitting elements;
a controller operably coupled to each of the plurality of key switches, the sound output device, the light-emitting apparatus, and the non-transitory computer-readable medium, the controller being configured to:
receive an input from the plurality of key switches;
identify an identified sound sample associated with the key switch from which the input was received;
play the identified sound sample for a duration the input is received;
identify an identified color associated with the key switch from which the input was received;
operate the light-emitting apparatus such that at least one light-emitting element of the plurality of light-emitting elements is emitting the identified color for the duration the input is received; and
when receiving two or more concurrent inputs from two or more key switches:
identify a first identified color associated with a first key switch from one of the two or more concurrent inputs was received;
identify a second identified color associated with a second key switch from another of the two or more concurrent inputs was received; and
operate the light-emitting apparatus such that a pattern resulting from at least one light-emitting element of the plurality of light-emitting elements emitting the first identified color and at least one light emitting element of the plurality of light-emitting elements emitting the second identified color.

2. The piano system of claim 1 wherein the controller is configured to, when receiving two concurrent inputs from a first key switch and a second key switch:
identify a first identified color associated with the first key switch;
identify a second identified color associated with the second key switch; and
operate the light-emitting apparatus such that the light-emitting elements of the plurality of light-emitting elements are alternated in a repeating pattern to emit one of the first identified color or the second identified color along a length of the light-emitting apparatus.

3. The piano system of claim 1 wherein the controller is configured to, when receiving three concurrent inputs from a first key switch, a second key switch; and a third key switch:
identify a first identified color associated with the first key switch;
identify a second identified color associated with the second key switch;
identify a third identified color associated with the third key switch; and
operate the light-emitting apparatus such that the light-emitting elements of the plurality of light-emitting elements are alternated in a repeating pattern to emit one of the first identified color, the second identified color, or the third identified color along a length of the light-emitting apparatus.

4. The piano system of claim 1 wherein the pattern resulting from at least one light-emitting element of the plurality of light-emitting elements emitting the first identified color and at least one light emitting element of the plurality of light-emitting elements emitting the second identified color is a repeating striped pattern.

5. The piano system of claim 4 wherein the controller is further configured to change the color of light emitted by each light-emitting element of the plurality of light-emitting elements as time progresses, with a light-emitting element of the plurality of light emitting elements emitting the first identified color at a first moment in time during which the concurrent input of two or more key switches is received and the second identified color at a second moment in time subsequent to the first moment in time during which the concurrent input of two or more key switches is received, the concurrent input of the two or more key switches having been received continuously between the first moment in time and the second moment in time.

6. The piano system of claim 5 wherein the controller is configured to change the color of light emitted by each light-emitting element of the plurality of light-emitting elements as time progresses, simulating motion of the pattern as it is observable by a user onto the upper surface of plurality of keys.

7. The piano system of claim 5 wherein the controller is further configured to, upon ceasing to receive an input from one of the two or more key switches with which the second identified color is identified while continuing to receive the other inputs of the two or more key switches, operate the light-emitting apparatus to emit at least the first identified color and to not emit the second identified color.

8. The piano system of claim 1 wherein the controller is configured to operate the light-emitting apparatus such that at least one light-emitting element of the plurality of light-emitting elements is emitting the identified color at a first intensity when the controller first operates the light-emitting apparatus responsive to receiving the key switch and decreasing the intensity at which the identified color is emitted throughout the duration the input is received.

9. The piano system of claim 8 wherein the controller is configured to, upon receiving a first input from a first key switch at a first moment in time and a second input from a second key switch at a second moment in time subsequent to the first moment in time:
identify a first identified color associated with the first key switch;
operate the light-emitting apparatus to emit the first identified color at the first intensity and decreasing the intensity of the first identified color emitted by the light-emitting apparatus as time progresses, such that the light-emitting apparatus is emitting the second identified color at a second intensity when the second input is received;
identify a second identified color associated with the second key switch;
operate the light-emitting apparatus to emit the second identified color at the first intensity and the first identified color at the second intensity; and
decreasing the intensity each of the first identified color and the second identified color emitted by the light-emitting apparatus as time progresses.

10. A kit for retrofitting a piano comprising a keyboard comprising a plurality of keys and a plurality of key switches actuatable by the keys and a sound output device, the kit comprising:
a light-emitting apparatus comprising a plurality of multi-color light-emitting elements, the light-emitting apparatus being configured to be positioned to emit light onto an upper surface of the plurality of keys, and the light-emitting elements being operable to emit light in a plurality of colors;
a non-transitory computer-readable medium having stored thereon:
a plurality of sound samples;
a mapping associating each key switch of the plurality of key switches with a sound sample of the plurality of sound samples; and
a mapping associating each key switch with a color of the plurality of colors capable of being emitted by the plurality of light-emitting elements;
a controller configured to be coupled to each of the plurality of key switches, the sound output device, the light-emitting apparatus, and the non-transitory computer-readable medium, the controller being configured to:
receive an input from the plurality of key switches;
identify an identified sound sample associated with the key switch from which the input was received;
play the identified sound sample for a duration the input is received;
identify an identified color associated with the key switch from which the input was received;
operate the light-emitting apparatus such that at least one light-emitting element of the plurality of light-emitting elements is emitting the identified color for the duration the input is received; and
when receiving two or more concurrent inputs from two or more key switches:
identify a first identified color associated with a first key switch from one of the two or more concurrent inputs was received;
identify a second identified color associated with a second key switch from another of the two or more concurrent inputs was received; and
operate the light-emitting apparatus such that a pattern resulting from at least one light-emitting element of the plurality of light-emitting elements is emitting the first identified color and at least one light emitting element of the plurality of light-emitting elements is emitting the second identified color.

11. The kit of claim 10 wherein the controller is configured to, when receiving two concurrent inputs from a first key switch and a second key switch:
identify a first identified color associated with the first key switch;
identify a second identified color associated with the second key switch; and
operate the light-emitting apparatus such that the light-emitting elements of the plurality of light-emitting elements are alternated in a repeating pattern to emit one of the first identified color or the second identified color along a length of the light-emitting apparatus.

12. The kit of claim 10 wherein the controller is configured to, when receiving three concurrent inputs from a first key switch, a second key switch; and a third key switch:
identify a first identified color associated with the first key switch;
identify a second identified color associated with the second key switch;
identify a third identified color associated with the third key switch; and
operate the light-emitting apparatus such that the light-emitting elements of the plurality of light-emitting elements are alternated in a repeating pattern to emit one of the first identified color, the second identified color, or the third identified color along a length of the light-emitting apparatus.

13. The kit of claim 10 wherein the pattern resulting from at least one light-emitting element of the plurality of light-emitting elements emitting the first identified color and at least one light emitting element of the plurality of light-emitting elements emitting the second identified color is a repeating striped pattern.

14. The kit of claim 13 wherein the controller is further configured to change the color of light emitted by each light-emitting element of the plurality of light-emitting elements as time progresses, with a light-emitting element of the plurality of light emitting elements emitting the first identified color at a first moment in time during which the concurrent input of two or more key switches is received and the second identified color at a second moment in time subsequent to the first moment in time during which the concurrent input of two or more key switches is received, the concurrent input of the two or more key switches having been received continuously between the first moment in time and the second moment in time.

15. The kit of claim 14 wherein the controller is configured to change the color of light emitted by each light-emitting element of the plurality of light-emitting elements as time progresses, simulating motion of the pattern as it is observable by a user onto the upper surface of plurality of keys.

16. The kit of claim 15 wherein the controller is further configured to, upon ceasing to receive an input from one of the two or more key switches with which the second identified color is identified while continuing to receive the other inputs of the two or more key switches, operate the light-emitting apparatus to emit at least the first identified color and to not emit the second identified color.

17. The kit of claim 10 wherein the controller is configured to operate the light-emitting apparatus such that at least one light-emitting element of the plurality of light-emitting elements is emitting the identified color at a first intensity when the controller first operates the light-emitting apparatus responsive to receiving the key switch and decreasing the intensity at which the identified color is emitted throughout the duration the input is received.

18. The kit of claim 17 wherein the controller is configured to, upon receiving a first input from a first key switch at a first moment in time and a second input from a second key switch at a second moment in time subsequent to the first moment in time:
identify a first identified color associated with the first key switch;
operate the light-emitting apparatus to emit the first identified color at the first intensity and decreasing the intensity of the first identified color emitted by the light-emitting apparatus as time progresses, such that the light-emitting apparatus is emitting the second identified color at a second intensity when the second input is received;
identify a second identified color associated with the second key switch;
operate the light-emitting apparatus to emit the second identified color at the first intensity and the first identified color at the second intensity; and
decreasing the intensity each of the first identified color and the second identified color emitted by the light-emitting apparatus as time progresses.

19. A method of providing visual responses when using a keyboard comprising a plurality of keys and a plurality of key switches, each key switch being actuatable by a key of the plurality of keys, a sound output device, and a light-emitting apparatus comprising a plurality of multi-color light-emitting elements, the light-emitting apparatus being positioned to emit light onto an upper surface of the plurality of keys, and the light-emitting elements being operable to emit light in a plurality of colors, a non-transitory computer-readable medium having stored thereon a plurality of sound samples, a mapping associating each key switch of the plurality of key switches with a sound sample of the plurality of sound samples, and a mapping associating each key switch with a color of the plurality of colors capable of being emitted by the plurality of light-emitting elements, and a controller operably coupled to each of the plurality of key switches, the sound output device, the light-emitting apparatus, and the non-transitory computer-readable medium, the method comprising:
receiving two or more concurrent inputs from two or more key switches;
identifying an identified sound sample associated with each key switch from which the inputs of the two or more concurrent inputs was received;
playing the identified sound sample for a duration of the inputs of the concurrent inputs are received;
identifying a first identified color associated with a first key switch from one of the two or more concurrent inputs was received;
identifying a second identified color associated with a second key switch from another of the two or more concurrent inputs was received; and
operating the light-emitting apparatus to emit light onto the upper surface of the plurality of keys such that a pattern resulting from at least one light-emitting element of the plurality of light-emitting elements emitting the first identified color and at least one light emitting element of the plurality of light-emitting elements emitting the second identified color.

20. The method of claim 19 wherein the pattern resulting from at least one light-emitting element of the plurality of light-emitting elements emitting the first identified color and at least one light emitting element of the plurality of light-emitting elements emitting the second identified color is a repeating striped pattern.

21. The method of claim 20 further comprising changing the color of light emitted by each light-emitting element of the plurality of light-emitting elements as time progresses, with a light-emitting element of the plurality of light emitting elements emitting the first identified color at a first moment in time during which the concurrent input of two or more key switches is received and the second identified color at a second moment in time subsequent to the first moment in time during which the concurrent input of two or more key switches is received, the concurrent input of the two or more key switches having been received continuously between the first moment in time and the second moment in time.

22. The method of claim 21 further comprising changing the color of light emitted by each light-emitting element of the plurality of light-emitting elements as time progresses, simulating motion of the pattern as it is observable by a user onto the upper surface of plurality of keys by.

23. The method of claim 21 further comprising, upon ceasing to receive an input from one of the two or more key switches with which the second identified color is identified while continuing to receive the other inputs of the two or more key switches, operating the light-emitting apparatus to emit at least the first identified color and to not emit the second identified color.
